(19) United States
(12) Patent Application Publication
(10) Pub. No.: US 2026/0299570 A1
(43) Pub. Date: Oct. 1, 2026

(54) SYSTEM AND METHOD FOR MANAGING PLANT OPERATIONS

(71) Applicant: Yokogawa Electric Corporation, Tokyo (JP)

(72) Inventors: Vijaya Rama Raju PENUMATCHA, Bangalore (IN); M K Naveen KASHYAP, Bangalore (IN); Adidev KATIYAR, Bangalore (IN)

(21) Appl. No.: 19/415,441

(22) Filed: Dec. 10, 2025

(30) Foreign Application Priority Data
Mar. 26, 2025 (IN) 202511028396
Nov. 19, 2025 (IN) 202513113935

(51) Int. Cl. G05B 19/418

(52) U.S. Cl. CPC G05B 19/41885; G05B 2219/32335

(57) ABSTRACT

The present invention relates to a system and method for managing plant operations. The system comprises a user interface, a context extraction engine, and a decision server. The user interface enables the selection of at least one plant subsystem from a plurality of plant subsystems and receives a prompt related to the at least one subsystem. The context extraction engine employs one or more context-aware models and selectively activates the at least one context-aware model for generating a contextual hypothesis or checking data sufficiency for the selected plant subsystem, based on at least one derived variable from the prompt and corresponding real-time variable values. The decision server evaluates the contextual hypothesis to generate contextual data for providing one or more control actions. This enables the dynamic, accurate, and adaptive generation of contextual intelligence, significantly enhancing plant performance and operational efficiency.

### CROSS-REFERENCE TO RELATED APPLICATIONS

The present application claims the benefit of and priority Indian Patent Application No. 202511028396, filed on Mar. 26, 2025. The present application also claims the benefit of and priority Indian Application No. 202513113935, filed on Nov. 19, 2025, entitled “SYSTEM AND METHOD FOR MANAGING PLANT OPERATIONS”, all of which are hereby incorporated herein by reference in their entireties.

### FIELD OF THE INVENTION

The present invention relates to a distributed autonomous system, and more particularly, the present invention relates to a distributed autonomous system for managing plant operations and improving decision-making. More specifically, the present invention relates to a system and method for managing plant operations. This provides a transformative industrial capability by enabling a highly efficient and intelligent plant management architecture, designed to deliver substantial operational improvements and tangible advantages over conventional approaches.

### BACKGROUND

### Interpretation Considerations

This section describes the technical field in detail and discusses problems encountered in the technical field. Therefore, statements in the section are not to be construed as prior art.

### DISCUSSION

In modern industrial plants, automation plays a crucial role in enhancing operational efficiency, reducing human intervention, and ensuring consistent quality in production. Traditional plant operations often rely on manual control and monitoring, which can lead to inefficiencies, increased downtime, and potential safety hazards.

With the advent of the Industrial Internet of Things (IIoT), artificial intelligence (AI), and advanced control systems, industries have progressively shifted toward automated solutions. The systems enable real-time data acquisition, predictive maintenance, and remote monitoring of equipment and processes. However, existing automation frameworks often face challenges in scalability, interoperability, and adaptability to varying operational conditions.

One key challenge is integrating disparate automation systems across different plant sections. Many industrial plants operate with heterogeneous systems from multiple vendors, leading to data silos and inefficiencies in communication between control units. Additionally, while Programmable Logic Controllers (PLCs) and Supervisory Control and Data Acquisition (SCADA) systems are widely used, they lack the advanced decision-making capabilities required for dynamic optimisation of plant processes.

Another issue in current industrial automation is the real-time response to system anomalies. Conventional automation frameworks primarily rely on predefined rule-based logic, which may not be sufficient for handling unexpected failures, sudden demand changes, or environmental variations. Consequently, plant operators often need to intervene manually, resulting in delays, production losses, and higher operational costs.

Thus, there is a need for an advanced industrial automation system that integrates real-time analytics, adaptive process control, and seamless interoperability to optimise plant operations. The present invention addresses these challenges by providing an improved automation framework that enhances efficiency, reduces downtime, and improves decision-making in industrial plants.

Industrial plants have increasingly shifted from manual processes to automation-driven operations to achieve greater productivity, efficiency, and consistency. The move toward automation has enabled plant operators to reduce human error, streamline workflows, and optimize output across various industrial domains. Early advancements in process automation introduced programmable logic controllers (PLCs), sensors, and supervisory control systems that could monitor plant sections and support execution of pre-defined tasks with minimal human intervention. These advances marked the first step in transforming the management and operation of industrial plants.

Over time, more sophisticated systems were developed to improve upon traditional automation. These advanced systems offered features such as centralized monitoring dashboards, integration of limited analytical tools, and support for basic predictive maintenance functionalities. The benefits of such automated solutions included higher efficiency, predictable production cycles, consistent output, and reduced downtime due to equipment faults. Additionally, integration of software-based tools provided decision support by offering insights based on historical plant data and operational trends. Collectively, such developments laid the foundation for modern industrial practices, which are now progressively aligning with Industry 4.0 standards.

However, despite these advancements, traditional and even specific modern systems continue to face significant limitations. Traditional industrial systems struggle to generate valid contextual data for various sections of an industrial plant, making it challenging to provide customized insights necessary for informed decision-making. Further, the systems also face challenges in integrating and harmonizing data streams arriving in diverse formats from multiple subsystems within the plant. A significant shortcoming lies in the inability to generate real-time contextual data or automatically retrieve and update crucial operational information from knowledge sources, such as manuals or process guides, related to specific plant areas. As a result, the data often remains static, incomplete, and outdated, which slows down decision-making and limits effective control.

These issues compound further when user-generated prompts need to be combined with real-time sensor values or subsystem-specific operational states. In most conventional systems, the merging of such information either does not occur or occurs inefficiently, resulting in delayed, less adaptive, and less accurate decisions. This, in turn, hampers productivity, efficiency, and safety improvements that should otherwise be achievable through automation. Moreover, incorporating advanced AI models, such as large language models, into these environments is challenging due to high computational requirements, long response times, and synchronization issues.

There is a strong need for a system and method that seamlessly integrates user prompts with real-time plant-specific data, facilitates the automated generation of contextual intelligence, and enables faster and more adaptive decision-making, thereby significantly enhancing operational intelligence, responsiveness, and overall plant performance.

### SUMMARY

According to an aspect of the present invention, the invention provides a distributed autonomous system comprising one or more interconnected subsystems and a processor. The one or more interconnected subsystems perform plant operations. The processor is connected to the one or more interconnected subsystems and is configured to provide an interface, detect at least one variable and at least one constraint of the subsystem, and simulate a behaviour of the distributed autonomous system based on a desired output. Further, the processor monitors the variable and the constraint of the subsystem, determines a current state of the subsystem based on the monitoring, predicts an optimised workflow to achieve the desired output using the current state and the simulated behaviour of the distributed autonomous system, and initiates a trigger in the subsystem to achieve a predicted next target state of the optimised workflow. This system enhances automation by integrating real-time monitoring, simulation, and predictive optimisation within distributed environments.

In an embodiment of the present invention, the processor is configured to simulate the behaviour of the distributed autonomous system using a digital twin that replicates the operational characteristics, dynamic interactions, and real-time responses of the distributed autonomous system.

In an embodiment of the present invention, the processor is configured to develop an information model for the subsystem and integrate the information model into a unified information model for the distributed autonomous system. The processor is configured to detect the at least one variable and the at least one constraint of the subsystem using the unified information model. This integration enhances system coordination, predictive analysis, and optimisation of workflows, ensuring efficient operation and adaptability to achieve desired outcomes.

In an embodiment of the present invention, the processor is configured to develop the information model for the subsystem using at least one design specification, technical specification, process flow diagram, service manual, datasheet, piping drawing, or instrumentation drawing. This approach enhances system coordination and operational efficiency while addressing complex plant operations.

In an embodiment of the present invention, the unified information model includes the information model of the one or more interconnected subsystems, relationship data between the one or more interconnected subsystems, and relationship data between the subsystem and the environment. The invention enhances overall system coordination, adaptability, and operational efficiency in complex distributed environments by integrating subsystem-specific and environmental relationships into a cohesive framework.

In another embodiment of the present invention, the processor is configured to generate an impact diagram of the one or more interconnected subsystems based on the at least one variable and the at least one constraint. The system enhances decision-making processes, optimises workflow adjustments, and improves operational efficiency in complex environments by leveraging the impact diagram.

In yet another embodiment of the present invention, the variable includes at least one of a dependent variable, a feedforward variable, or a feedback variable. The at least one dependent variable, a feedforward variable, or a feedback variable includes at least one process control variable, security-related variable, network-related variable, and inventory-related variable of the subsystem. This approach enhances system adaptability and operational efficiency in complex environments by addressing diverse subsystem-specific requirements.

In yet another embodiment of the present invention, the constraints include at least one of a hard constraint, a soft constraint, or a quality constraint. The hard constraint includes at least an equipment-related constraint or sizing constraint, the soft constraint includes deviations from the desired output, and the quality constraint includes a desired quality of an end product. The processor enhances the system's ability to optimise workflows, ensure compliance with operational standards, and improve overall product quality in complex environments by effectively managing diverse constraints. The system can also automatically generate quality reports that are compliant with quality standards and regulations. Further, the system can highlight any gaps or white spaces in the compliance and generate recommendations to fill the gaps.

In still another embodiment of the present invention, the constraints include physical, operational, integrational, or regulatory constraints of the subsystem. The physical, operational, integrational, or regulatory constraints include temperature limits, pressure limits, minimum or maximum batch sizes, insufficient supply of raw materials, throughput limits, demand fluctuations, desired output fluctuations, or quality constraints of the subsystem. The processor enhances the system's ability to optimise workflows, ensure compliance with operational standards, and improve adaptability and efficiency in managing complex subsystem interactions by addressing diverse constraints.

In yet another embodiment of the present invention, the interface is configured to allow a user to set at least one desired output or a target state for the subsystem.

In another embodiment of the present invention, the interface provides an immersive view of the distributed autonomous system, including interactive control of a hierarchical structure and individual components of the subsystem. The interface enhances situational awareness and facilitates effective management of complex operations by enabling users to engage with the system in an immersive manner. This capability supports improved decision-making processes and operational efficiency within dynamic environments.

In another embodiment of the present invention, the one or more interconnected subsystems are connected through at least one industrial control system, an enterprise system, or an industrial data exchange system. By leveraging the advanced connectivity frameworks, the present invention enhances system integration, adaptability, and operational efficiency in managing complex distributed environments.

Therefore, an object of the present invention is to provide a system that leverages the unified information model of the distributed autonomous system to detect the variables and the constraints of the interconnected subsystems, predict an optimised workflow and next target state of the subsystem, and initiate an action to achieve the desired output of the distributed system.

An objective of the present invention is to provide a system and method that enable the dynamic and continuous generation of real-time, subsystem-specific contextual data, derived by extracting information from prompts, operational data, or real-time data from plant-specific subsystems, thereby improving accuracy, responsiveness, and decision-making efficiency in plant operations.

Another objective of the present invention is to provide a selective, context-aware model activation that generates precise contextual insights, optimized data handling that reduces decision-making enabled by targeted data processing redundancy and lowers computational loads, and faster, more accurate for improved responsiveness.

Yet another objective of the present invention is to provide a system and method that ensures continuous model improvement via fine-tuning by large language models, maintains ongoing relevance by aligning predictive processing with evolving plant data, documentation, and regulatory standards, user prompts and delivers significant operational impact through enhanced safety, greater productivity, proactive maintenance, and improved cost-effectiveness as compared to conventional plant management systems.

This and other objectives are achieved by providing a system and method for managing plant operations as defined in the features of the independent claims. Additional advantageous embodiments and improvements of the invention are listed in the dependent claims. The use of expressions like “…aspect according to the invention” or “in one embodiment” or similar terminology is intended to refer to examples or embodiments consistent with the broadest scope of the invention as defined by the independent claims.

According to a first aspect, the present invention discloses a system for managing plant operations. The system comprises a user interface, a context extraction engine, and a decision server. The user interface enables selection of at least one plant subsystem from a plurality of plant subsystems and receives a prompt related to the at least one subsystem. The context extraction engine employs one or more context-aware models and selectively activates the at least one context-aware model for generating a contextual hypothesis or checking data sufficiency for the selected plant subsystem, based on at least one derived variable from the prompt and corresponding real-time variable values. The decision server evaluates the contextual hypothesis to generate contextual data for providing one or more control actions. This enables the dynamic, accurate, and adaptive generation of contextual intelligence, significantly enhancing plant performance and operational efficiency.

In an embodiment of the present invention, the user interface includes a semantic parser that interprets the prompt and converts the prompt into structured tuning directives. Thereby improves usability, reduces ambiguities, and enhances precision in plant operation management.

In another embodiment of the present invention, the one or more context-aware models are trained and tuned on at least one of a set of subsystems of the plant or a predefined purpose. This improves the relevance, accuracy, and adaptability of contextual intelligence for plant operations.

In another embodiment of the present invention, the real-time variable values are received from one or more interconnected subsystems of the plant through a communication network. This enables the timely, synchronized, and accurate generation of contextual intelligence for effective plant operation management.

In another embodiment of the present invention, one or more context-aware models employ at least one of a rule-based model, a statistical model, or a generative artificial intelligence (AI) model. This enhances the robustness, scalability, and adaptability of contextual intelligence for varied plant operation scenarios.

In yet another embodiment of the present invention, the decision server evaluates the contextual hypothesis by validating the generated contextual hypothesis or context of the checked data sufficiency against the prompt using one or more statistical consistency tests. This increases accuracy, reduces errors, and enhances trust in automated plant decision-making.

In yet another embodiment of the present invention, the unresolved or invalid outcomes from the contextual hypothesis generation or a non-resolvable context from the checked data sufficiency are transferred to a large language model for generating and providing contextual data to the at least one context-aware model for training. This enables continuous learning and improvement of context-aware models, thereby enhancing adaptability, accuracy, and resilience in handling complex plant operation scenarios.

In another embodiment of the present invention, valid outcomes corresponding to the prompt adjust at least one of the embedding vectors representing the prompt, adapter weights, or the attention mechanism of the at least one context-aware model. This improves contextual accuracy, personalization, and overall efficiency of plant operation management.

In another embodiment of the present invention, the large language model requests an additional prompt when the large language model is incapable of processing the non-resolvable context to generate the contextual data. This minimizes gaps, enhances reliability, and supports robust decision-making in plant operations.

In another embodiment of the present invention, the at least one context-aware model is iteratively refined based on user feedback. This enhances accuracy, relevance, and long-term efficiency in managing plant operations.

According to a second aspect of the invention, the present invention discloses a method for managing plant operations. The method comprises steps of: a) receiving a user input to enable selection of at least one plant subsystem from a plurality of plant subsystems and a prompt related to the at least one subsystem; b) deriving at least one variable from the received user input and acquiring corresponding real-time variable values from the plant; c) activating at least one context-aware model corresponding to at least one plant subsystem for generating a contextual hypothesis or checking data sufficiency using the derived variable and the corresponding real-time variable values; and d) evaluating the contextual hypothesis to generate the contextual data for providing one or more control actions. This establishes a structured and intelligent workflow that translates user inputs and plant data into precise control actions, thereby enhancing decision-making speed, operational accuracy, and overall plant efficiency.

In an embodiment of the present invention, evaluating the contextual hypothesis includes validating the generated contextual hypothesis or context of the checked data sufficiency against the prompt using one or more statistical consistency tests. This ensures accuracy, consistency, and reliability of contextual intelligence for plant operations.

In another embodiment of the present invention, evaluating the contextual hypothesis comprises generating contextual data using a large language model and providing the generated contextual data to at least one context-aware model for training in response to unresolved or invalid outcomes from evaluating the contextual hypothesis or non-resolvable context from data sufficiency checking. This enables continuous learning and resolution of complex scenarios, thereby improving model robustness and adaptability.

In yet embodiment of the present invention, evaluating the contextual hypothesis comprises adjusting at least one of the embedding vectors representing the prompt, adapter weights, or the attention mechanism of the at least one context-aware model in response to valid outcomes. This allows adaptive refinement of model parameters, thereby increasing contextual accuracy and personalization for effective plant management.

In still another embodiment of the present invention, evaluating the contextual hypothesis comprises requesting an additional prompt when the large language model is incapable of processing the non-resolvable context to generate the contextual data. This ensures uninterrupted contextual intelligence generation by seeking clarifications, thereby minimizing operational disruptions and improving decision reliability.

In still another embodiment of the present invention, activating at least one context-aware model includes transferring the request to a large language model and tuning the one or more context-aware models on at least one of a set of subsystems of the plant or a predefined purpose. This ensures customized tuning of models for specific plant subsystems or objectives, thereby enhancing the relevance and efficiency of decision-making.

### BRIEF DESCRIPTION OF THE DRAWINGS

The drawings illustrate the design and utility of embodiments of the present invention, in which common reference numerals refer to similar elements. In order to better appreciate the advantages and objects of the embodiments of the present invention, reference should be made to the accompanying drawings that illustrate these embodiments. However, the drawings depict only some embodiments of the invention and should not be taken as limiting its scope. With this caveat, embodiments of the invention will be described and explained with additional specificity and detail through the use of the accompanying drawings in which:

FIG. 1 illustrates a block diagram of a distributed autonomous system in accordance with an exemplary embodiment of the present invention;

FIG. 2 illustrates a layer-wise architecture of a distributed autonomous system in accordance with another exemplary embodiment of the present invention;

FIG. 3 illustrates a flowchart of a method for developing a unified information model in accordance with an exemplary embodiment of the present invention;

FIG. 4A provides an illustration of an interface for controlling a distributed autonomous system in accordance with an exemplary embodiment of the present invention;

FIG. 4B provides an illustration of an interface for controlling a distributed autonomous system in accordance with another exemplary embodiment of the present invention;

FIG. 5 discloses an illustration of a distributed autonomous system in accordance with another exemplary embodiment of the present invention;

FIG. 6A illustrates a system for managing plant operations in accordance with an exemplary embodiment of the present invention;

FIG. 6B illustrates a system for managing plant operations in accordance with another exemplary embodiment of the present invention; and

FIG. 7 illustrates a method for managing plant operations in accordance with an exemplary embodiment of the present invention.

### DETAILED DESCRIPTION

The present disclosure is best understood with reference to the detailed figures and description set forth herein. Various embodiments have been discussed with reference to the figures. However, a person skilled in the art will readily appreciate that the detailed descriptions provided herein with respect to the figures are merely for explanatory purposes, as the methods and system may extend beyond the described embodiments. For instance, the teachings presented, and the needs of a particular application may yield multiple alternatives and suitable approaches to implement the functionality of any detail described herein. Therefore, any approach may extend beyond certain implementation choices in the following embodiments.

Methods of the present invention may be implemented by performing or completing, executing manually, automatically, or a combination thereof, selected steps or tasks. The term “method” refers to manners, means, techniques, and procedures for accomplishing a given task, including, but not limited to, those manners, means, techniques, and procedures either known to or readily developed from known manners, means, techniques, and procedures by practitioners of the art to which the invention belongs. The descriptions, examples, methods, and materials presented in the claims and the specification are not to be construed as limiting but rather as illustrative only. Those skilled in the art will envision many other possible variations within the scope of the technology described herein.

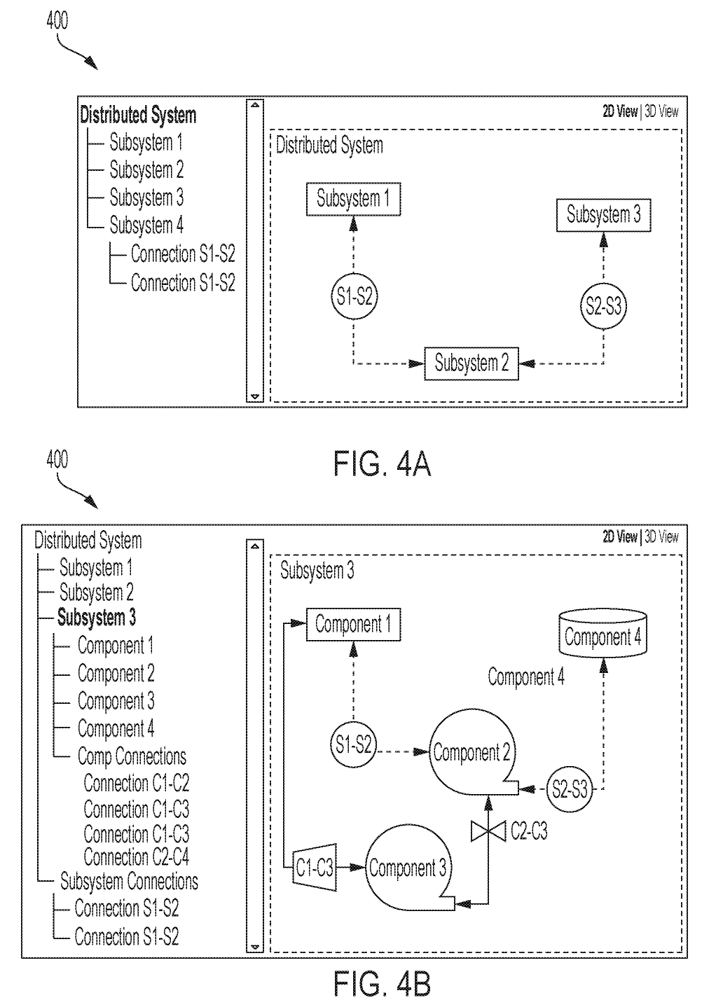

FIG. 1 illustrates a block diagram of a distributed autonomous system 100 in accordance with an exemplary embodiment of the present invention. The distributed autonomous system 100 comprises one or more interconnected subsystems (101-1, 101-2, 101-3, 101-N) and a processor 102 connected with one or more interconnected subsystems (101-1, 101-2, 101-3, 101-N). The processor 102 is configured to provide an interface (explained in FIGS. 4A and 4B), detect at least one variable and at least one constraint of the subsystem 101-1 and simulate a behaviour of the distributed autonomous system 100 based on a desired output, monitor the variable and the constraint of the subsystem 101-1, determine a current state of the subsystem 101-1 based on the monitoring, predict an optimised workflow to achieve the desired output using the current state and the simulated behaviour of the distributed autonomous system 100, and initiate a trigger in the subsystem 101-1 to achieve a predicted next target state of the optimised workflow.

The one or more interconnected subsystems (101-1, 101-2, 101-3, 101-N) include at least one of a process control subsystem, mechanical subsystem, utility subsystem, electrical subsystem, power management subsystem, manufacturing operation subsystem, or a safety subsystem.

The one or more interconnected subsystems (101-1, 101-2, 101-3, 101-N) are connected through at least one industrial control system, an enterprise system, or an industrial data exchange system. The industrial control system includes at least one Supervisory Control and Data Acquisition (SCADA), Distributed Control System (DCS), or Programmable Logic Controller (PLC). The enterprise system includes at least one Enterprise Resource Planning (ERP), Manufacturing Execution System (MES), Supply Chain Management (SCM), or Product Lifecycle Management (PLM). The industrial data exchange system includes at least one of Message Queuing Telemetry Transport (MQTT), Industrial Internet of Things (IIoT), Modbus, Process Field Network (PROFINET), or Ethernet protocols. Alternatively, the industrial control system, enterprise system, or industrial data exchange system may also act as independent interconnected subsystems.

For example, in a steel manufacturing plant, the one or more interconnected subsystems (101-1, 101-2, 101-3, 101-N) ensure smooth production, efficiency, and safety. The process control and automation subsystem regulates operations such as raw material handling, blast furnace control, and rolling mill automation. The mechanical and utility subsystems, such as high-capacity motors, compressors, cooling systems, and steam boilers, support heavy machinery and maintain optimal temperatures. The power management subsystems, including energy distribution, transformers, and backup generators, ensure an uninterrupted power supply, critical for processes like electric arc furnace (EAF) operations. The manufacturing operation subsystems track steel production stages from iron ore processing to hot rolling and finished product inspection. The safety subsystems, including gas leak detection, fire suppression, dust collection, and wastewater treatment, protect workers and ensure compliance with environmental regulations. The industrial data exchange protocols, as a subsystem or an interconnection medium, use the IIoT, artificial intelligence-driven predictive maintenance, and real-time monitoring to enhance operational efficiency. The enterprise subsystems such as the ERP, SCM, and PLM manage inventory, supply chain logistics, and customer orders. The plurality of subsystems works together and enables the plant to produce high-quality steel efficiently while maintaining safety and sustainability.

Preferably, each of the one or more interconnected subsystems (101-1, 101-2, 101-3, 101-N) has at least one design specification, technical specification, process flow diagram, service manual, datasheet, piping drawing, or instrumentation drawing. The processor 102 is configured to fetch or scan the documents associated with the one or more interconnected subsystems (101-1,101-2, 101-3, 101-N) to extract at least one variable, constraint, associated parameters, and thresholds to develop information models for the one or more interconnected subsystems (101-1, 101-2, 101-3, 101-N). The processor 102 further processes the individual information model of the subsystem and integrates the information into a unified information model of the distributed autonomous system 100.

The processor 102 is arranged at a remote location from the one or more interconnected subsystems (101-1, 101-2, 101-3, 101-N). Alternatively, the processor 102 is arranged at a location of the more interconnected subsystems (101-1, 101-2, 101-3, 101-N). In another example, the processor 102 further comprises sub-processor modules (not shown in the figures), and the sub-processor modules are arranged at the location of the more interconnected subsystems (101-1, 101-2, 101-3, 101-N), and the processor 102 as a master processor is arranged at a remote location. In yet another example, the subsystems include an in-built processing unit, and the in-built processing unit is utilised as a sub-processor module of the processor 102. The arrangement of the processor 102 is preferably optimised to manage multiple subsystems distributed across different locations.

The processor 102 can be any commercially available processor or a cloud system. The processor 102 can also be implemented as a Digital Signal Processor (DSP), a controller, a microcontroller, a designated System on Chip (SoC), an integrated circuit implemented with a Field Programmable Gate Array (FPGA), an Application Specific Integrated Circuit (ASIC), or a combination thereof. The processor 102 can be implemented using a co-processor for complex computational tasks.

The processor 102 is connected to the one or more interconnected subsystems (101-1, 101-2, 101-3, 101-N) using at least one of a wired or a wireless communication protocol. The at least one wired communication protocol may include but is not limited to an ethernet (IEEE 802.3), a power line communication, a control pilot (CP) such as a local interconnect network (LIN), a controller area network (CAN), a media-oriented system transport (MOST), or a flexRay. The at least one wireless communication protocol may include but is not limited to radio frequency (RF), infrared (IrDA), Bluetooth, Zigbee (and other variants of the IEEE 802.15 protocol), a wireless fidelity Wi-Fi or IEEE 802.11 (any variation), IEEE 802.16 (WiMAX or any other variation), direct sequence spread spectrum (DSSS), frequency hopping spread spectrum (FHSS), global system for mobile communication (GSM), general packet radio service (GPRS), enhanced data rates for GSM Evolution (EDGE), long term evolution (LTE), cellular protocols (2G, 2.5G, 2.75G, 3G, 4G or 5G), near field communication (NFC), satellite data communication protocols, or any other protocols for wireless communication. Additionally, the processor 102 is connected to the one or more interconnected subsystems (101-1, 101-2, 101-3, 101-N) through at least one industrial control system, an enterprise system, or an industrial data exchange system.

Additionally, the processor 102 is configured to simulate the behaviour of the distributed autonomous system 100 by generating a virtual model or a digital twin of the distributed autonomous system 100 that accounts for historical performance data, environmental factors, and predictive analytics to forecast system behaviour under varying conditions. The processor 102 executes computational algorithms to evaluate different operational scenarios and predict potential deviations from the desired output. Based on this predictive analysis, the processor 102 determines an optimised workflow that aligns the subsystem operations to efficiently achieve the desired output while minimising inefficiencies, downtime, and resource wastage.

The processor 102 is configured to continuously monitor at least one variable and constraint associated with the one or more interconnected subsystems (101-1, 101-2, 101-3, 101-N) of the distributed autonomous system 100, which further includes real-time data acquisition from various sensors, actuators, and system logs, enabling the processor 102 to track the operational conditions of each subsystem. The processor 102 systematically collects and processes this data to ensure that all subsystems function within the predefined operational limits.

Based on the monitoring data, the processor 102 determines the current state of the distributed autonomous system 100 by analysing the real-time values of the monitored variables and comparing them against predefined operational constraints. The current state includes the exact operational condition of the system at a given moment, providing an accurate state of individual subsystems and their interactions within the larger autonomous system.

The optimised workflow of the distributed autonomous system 100 includes a dynamically adjusted sequence of operations to maximise efficiency, minimise resource wastage, and ensure seamless coordination between the one or more interconnected subsystems (101-1, 101-2, 101-3, 101-N).

For example, if the distributed autonomous system 100 is implemented in a water treatment plant, where multiple interconnected subsystems (101-1, 101-2, 101-3, 101-N) perform various plant operations such as raw water intake, filtration, chemical treatment, sedimentation, storage, and distribution. A processor 102 is operatively connected to the subsystems (101-1, 101-2, 101-3, 101-N) to enable real-time monitoring, simulation, and optimisation of plant performance based on predefined operational objectives. The processor 102 provides an interface that allows the user to input a desired output, such as a target water quality standard, specific flow rate, optimised chemical consumption levels, or optimised filtration rate to minimise energy consumption. Subsequently, the processor 102 detects variables such as inflow rate, turbidity levels, pH balance, chemical dosing levels, filtration pressure, sedimentation efficiency, storage tank levels, and/or water demand forecasts. Based on the user-defined parameters, the processor 102 simulates the behaviour of the water treatment system, allowing predictive analysis of system performance under different conditions. In case, an increase in turbidity levels is detected in the incoming raw water due to heavy rainfall. The processor 102, using simulation models, predicts the impact of this change on the filtration and sedimentation processes and determines an optimised workflow to maintain the user-defined water quality. The optimised workflow may include adjusting the chemical dosing levels, modifying filtration rates, and increasing sedimentation time to ensure the efficient removal of suspended particles while meeting the desired turbidity level set by the user. Additionally, the processor 102 can trigger an increase in backwashing frequency for filtration units to prevent clogging and maintain operational efficiency. If the simulation predicts a potential overflow in the storage subsystem due to an unexpected reduction in water demand, the processor 102 may initiate a controlled release of treated water into auxiliary storage tanks or modify pump operations to regulate output flow. The interface may further allow the user to adjust constraints and priorities, such as prioritising energy efficiency, chemical consumption, or rapid processing speed based on operational goals. The processor 102 continuously updates the simulation model with real-time data, ensuring adaptive decision-making that aligns plant operations with the user-defined output specifications. This integration of simulation-based prediction, user input, and autonomous control enhances overall system efficiency, ensuring uninterrupted water supply while maintaining regulatory compliance and operational safety.

The processor 102 may further be configured to generate an impact diagram of the one or more interconnected subsystems (101-1, 101-2, 101-3, 101-N) based on at least one variable and at least one constraint associated with the distributed autonomous system 100. The impact diagram provides a graphical representation of how changes in specific variables influence different subsystems, enabling a comprehensive understanding of system interdependencies and potential operational bottlenecks. The interdependencies may be derived from at least one feedback or feedforward variable of the one or more interconnected subsystems (101-1, 101-2,101-3, 101-N). The impact diagram may be dynamically updated based on real-time data, allowing the user to visualise the cause-and-effect relationships between multiple subsystems and the respective constraints. For example, in the context of a water treatment plant, if the turbidity level in the raw water intake subsystem increases due to external environmental factors such as heavy rainfall, the impact diagram may highlight cascading effects on filtration efficiency, sedimentation rates, chemical dosing requirements, and treated water quality. The processor 102, through simulation, determines how the variations propagate through the system 100 and displays the quantitative impact of the changes, such as an expected increase in coagulant dosage, a higher filtration pressure, or a longer sedimentation retention time required to maintain the desired water quality. The impact diagram may include the display of alarms and alerts in the form of colour variations, blinking indicators, or any other visual effects corresponding to the impacted element within the impact diagram. Specifically, upon detection of an anomaly, fault, or operational deviation within a subsystem or component, the system may generate a real-time alert, wherein the impacted element is visually highlighted to indicate the severity and nature of the issue. The visual effects may include, but are not limited to, colour coding based on predefined severity levels (e.g., red for critical failures, yellow for warnings, and green for normal operation), flashing indicators to attract immediate attention, or graphical overlays providing contextual information about the impact.

Additionally, the impact diagram can also reflect external influences, such as disruptions in pipeline flow, delays in chemical supply, fluctuations in power availability, or variations in water demand. If an external storage tank level drops due to an unexpected increase in consumer demand, the impact diagram may indicate potential shortages and recommend workflow adjustments, such as increasing pump speed or prioritising alternative water sources. Alternatively, the interface further enables the user to interact with the impact diagram, allowing them to simulate hypothetical scenarios by adjusting key variables and constraints, facilitating informed decision-making to optimise plant performance while adhering to predefined operational objectives.

The processor 102 may utilise artificial intelligence, including machine learning (ML), to enhance the efficiency and predictive capabilities of the configured steps or instructions in the distributed autonomous system 100. By continuously analysing historical and real-time data, the processor 102 uses ML algorithms to detect patterns, optimise decision-making, and improve system performance over time. The configured steps or instructions, including detecting variables and constraints, simulating behaviour, predicting optimised workflows, and initiating triggers, are dynamically refined using ML-based models.

As another example, if the distributed autonomous system 100 is implemented within a naphtha splitter unit, the system autonomously manages fractionation operations by continuously monitoring and adjusting process parameters. The processor 102, connected to multiple interconnected subsystems (101-1, 101-2, 101-3, 101-N), including a feed control subsystem, reboiler duty management subsystem, and reflux ratio control subsystem of the naphtha splitter unit, provides an interface for operators to define the desired output, such as target product purity or throughput. Upon receiving input, the processor 102 detects key variables and constraints such as feed temperature, column pressure, reflux ratio, and bottom product flow rate. Using historical data, real-time sensor inputs, and desired output, the processor 102 simulates the expected behaviour of the naphtha splitter to predict optimal operating conditions. By continuously monitoring the variables, the processor 102 determines the current state of the system 100 and evaluates its deviation from the desired operational targets.

By leveraging machine learning models and predictive analytics, the processor 102 identifies potential inefficiencies, energy losses, or process imbalances and predicts an optimised workflow that adjusts parameters to achieve the desired product specifications. For instance, if an increase in heavy components is detected, the processor 102 may automatically trigger adjustments such as increasing reboiler duty or modifying the reflux ratio to maintain separation efficiency. By dynamically initiating process triggers, the system 100 ensures continuous optimisation of naphtha splitting operations, reducing energy consumption, improving product yield, and enhancing overall plant efficiency.

The processor 102 may provide an interface by enabling user interaction with the distributed autonomous system through a graphical user interface (GUI), command-line interface (CLI), or application programming interface (API). This interface allows users to input desired operational outputs, configure constraints, and visualise system parameters in real-time. The processor 102 dynamically updates the interface by retrieving and displaying data from interconnected subsystems, including current state variables, constraints, and predictive analytics. Additionally, the interface facilitates bidirectional communication, allowing users to manually override system decisions, set priority parameters, or adjust thresholds as needed. Further implementations may integrate machine learning-driven recommendations within the interface, assisting operators by suggesting optimised workflows, predictive maintenance schedules, or real-time process adjustments. This ensures seamless interaction between human operators and the distributed autonomous system 100, enhancing decision-making and operational efficiency.

The distributed autonomous system 100 may comprises one or more interconnected subsystems (101-1, 101-2, 101-3, 101-N) that may be implemented in software, hardware, or a combination thereof. The hardware subsystems may include, but are not limited to, processors, memory units, communication modules, sensors, and actuators, and the software subsystems may comprise executable instructions, algorithms, machine-learning models, databases, or firmware configured to execute on one or more computing devices. The software subsystem may control hardware components based on input data, predefined rules, or real-time conditions.

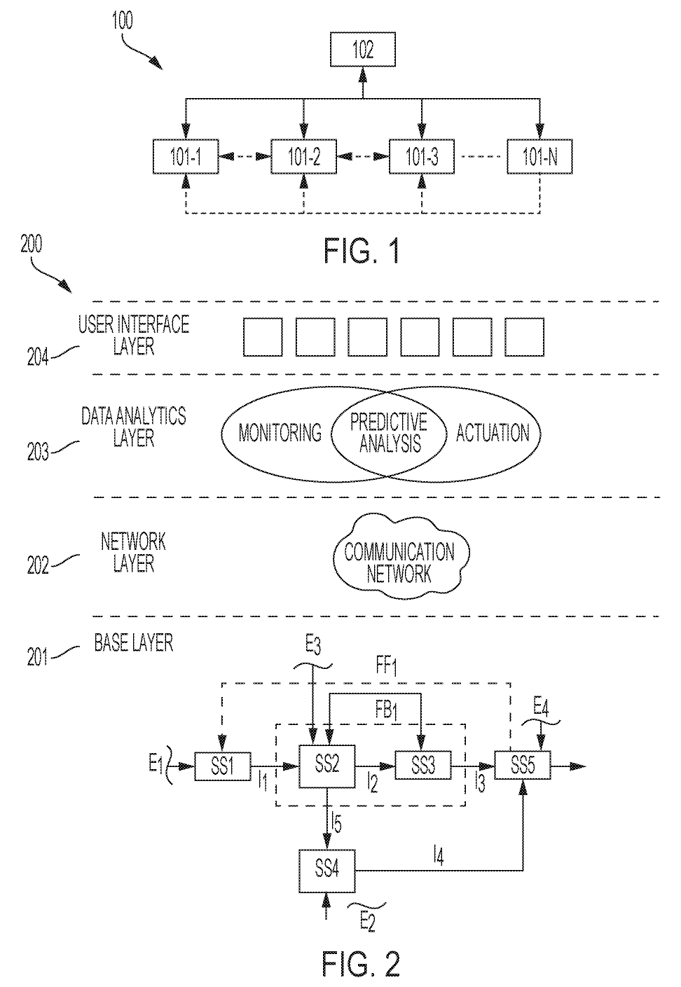

FIG. 2 illustrates a layer-wise architecture 200 of a distributed autonomous system in accordance with an exemplary embodiment of the present invention. The layer-wise architecture 200 of the distributed autonomous system comprises a base layer 201, a network layer 202, a data analytics layer 203, and a user interface layer 204. The base layer 201 comprises physical assets and operational components, including but not limited to sensors, actuators, industrial machinery, programmable logic controllers (PLCs), and distributed control systems (DCS). The base layer is configured to collect real-time operational data from multiple subsystems, such as material handling, production, quality control, and safety monitoring. The collected data is transmitted to a processor for analysis and command execution. The collected data is also locally analysed in each layer and subcomponent to achieve higher autonomy or sent to a processor.

The base layer 201 may further include a relationship diagram of the distributed autonomous system according to a unified information model. The unified information model includes the information model of the one or more interconnected subsystems, relationship data between the one or more interconnected subsystems, and relationship data between the subsystem and environment. The relationship data between the one or more interconnected subsystems may be derived based on feedback and feedforward variables exchanged therebetween. For example, a first subsystem may generate a feedback signal corresponding to an operational parameter, wherein said feedback signal is transmitted to a second subsystem to adjust its operational state. Concurrently, the second subsystem may generate a feedforward variable indicative of a predictive operational requirement, wherein said feedforward variable is transmitted to the first subsystem to proactively modulate its control parameters. The relationship data is thus determined based on the correlation between said feedback and feedforward variables, wherein such correlation may be analysed through predefined algorithms, machine learning models, or system identification techniques. Accordingly, the derived relationship data may be employed to optimise system performance, enhance interoperability between subsystems, and facilitate adaptive control mechanisms within a dynamically evolving operational environment.

Additionally, the relationship data between the subsystem and the environment may be derived based on environmental parameters influencing subsystem operation and corresponding subsystem responses. The subsystem may receive external data, including but not limited to temperature variations, pressure fluctuations, electromagnetic interference, or dynamic load conditions, wherein such data are captured through sensor-based feedback mechanisms. The subsystem may further generate feedforward signals to anticipate environmental changes and adjust operational parameters accordingly. The correlation between the received environmental feedback and the subsystem's feedforward response may be analysed to derive relationship data, which characterises dependencies, adaptive behavior, and system-environment interactions. Such relationship data may be utilised to optimise subsystem performance, enhance robustness against environmental disturbances, and facilitate predictive control strategies to maintain desired operational conditions.

For example, if the base layer 201 illustrates a shop floor or site, the base layer 201 includes one or more interconnected subsystems SS1, SS2, SS3 and SS4. The subsystems are fed with at least one input E1, E2, E3, and E4, which further include at least one of a sensor input, cloud data input and manual input. Based on the input, the subsystem further generates at least one output I1, I2, I3, and I4, which further includes at least one of last stage output, output signals, performance signals, cloud output, or performance matrix. Subsequently, the subsystems generate at least one feedback output FB1, which includes controlling output to another subsystem. The subsystem generates at least one feedforward output FF1, which includes a predictive output or stage to another subsystem.

In an illustration, in a distributed autonomous system implemented in a smart port environment, the system autonomously determines the optimal method for transferring a container from a ship to the port using automated cranes. The unified information model continuously monitors real-time operational data, including ship docking schedules, container weight, crane availability, port congestion levels, weather conditions, and storage capacity. Upon the arrival of a cargo ship, the system receives an input signal (E1) from sensor-equipped docking stations confirming the ship's position. The system then analyses feedforward variables (FF1) such as predicted crane availability, estimated unloading time, and optimal storage location within the port. Simultaneously, feedback variables (FB1) such as crane operational efficiency, real-time wind speed, and prior unloading delays are assessed to refine the unloading plan.

The processor leverages simulation models and historical data to evaluate multiple unloading scenarios. If one crane is experiencing delays, the system dynamically reallocates the task to another available automated crane. The processor also adjusts the container's transfer route based on congestion levels, choosing direct ground transport or an overhead conveyor system to optimise movement. By integrating dependent variables like ship stability constraints, real-time port traffic, and container stacking order, the system ensures that unloading operations are executed with maximum efficiency, minimal disruptions, and adherence to safety protocols. This autonomous decision-making process enables a seamless transfer of containers from the ship to the port storage, reducing delays and improving overall port efficiency.

Another example is if the distributed autonomous system is implemented within an industrial plant, and a valve is replaced within a processing subsystem, the system autonomously detects the change and updates the unified information model to maintain operational integrity and efficiency. Upon replacement, sensor inputs (E1) or manual input (E2) from a maintenance technician triggers the system to identify the new valve. The system queries vendor databases and digital records to retrieve the specifications of the replaced valve, including flow capacity, pressure rating, material composition, and compatibility with connected pipelines. This information is then cross-verified with historical procurement data and standard operating requirements to ensure compliance with plant regulations.

The system analyses feedforward variables (FF1) such as expected performance impact, potential need for recalibration of adjacent equipment, and predicted efficiency changes. Simultaneously, the system considers feedback variables (FB1), such as any discrepancies in real-time sensor readings, historical maintenance logs, and prior failure patterns, to refine the system’s operational response. In case the new valve has different flow characteristics, the processor dynamically adjusts process parameters across interconnected subsystems, such as pumps, pressure regulators, and control systems, to maintain stability. The unified information model is then updated to reflect the new component specifications, operational status, and relationship with other interconnected systems and environmental factors. This autonomous self-updating mechanism ensures that the system operates with the most up-to-date component data, reducing the risk of process inefficiencies, equipment mismatches, or unexpected failures, thereby enhancing plant reliability and performance.

The network layer 202 facilitates communication between the processor and various subsystems through industrial communication protocols. The network layer 202 may further include edge computing devices and gateways enabling the processor to execute distributed control strategies. Further cybersecurity mechanisms, such as encryption modules, firewalls, and intrusion detection systems within the network layer 202, ensure secure data transmission between subsystems and prevent unauthorised access.

The data analytics layer 203 processes, analyses, and stores operational data received from the subsystems via the processor. This layer comprises Manufacturing Execution Systems (MES), predictive maintenance models, artificial intelligence (AI) algorithms, machine learning (ML) frameworks, data historians, digital twin-based simulation tools, and energy management systems. The processor dynamically allocates resources, optimises production schedules, and executes predictive diagnostics by analysing real-time and historical data, thereby enhancing efficiency and reducing downtime across multiple subsystems. In particular, the processor utilises the data analytics layer 203 to predict an optimised workflow by evaluating the current state of the subsystems, identifying key variables and constraints, and simulating multiple operational scenarios using digital twin technology. The simulated scenarios are compared against historical data to anticipate potential inefficiencies, bottlenecks, and failures, allowing the system to proactively adjust process parameters, reallocate resources, or modify scheduling to achieve the desired output with maximum efficiency.

The user interface layer 204 provides monitoring, control, and decision-making capabilities for human operators and system administrators. This layer comprises one or more of Human-Machine Interfaces (HMI), web-based dashboards, mobile applications, or augmented reality (AR) or Supervisory Control and Data Acquisition (SCADA). The processor enables real-time visualisation, alert generation, remote access to plant operations, and operator guidance for troubleshooting. The layered architecture is a logical distribution of the functionality and can be performed by a single machine or component.

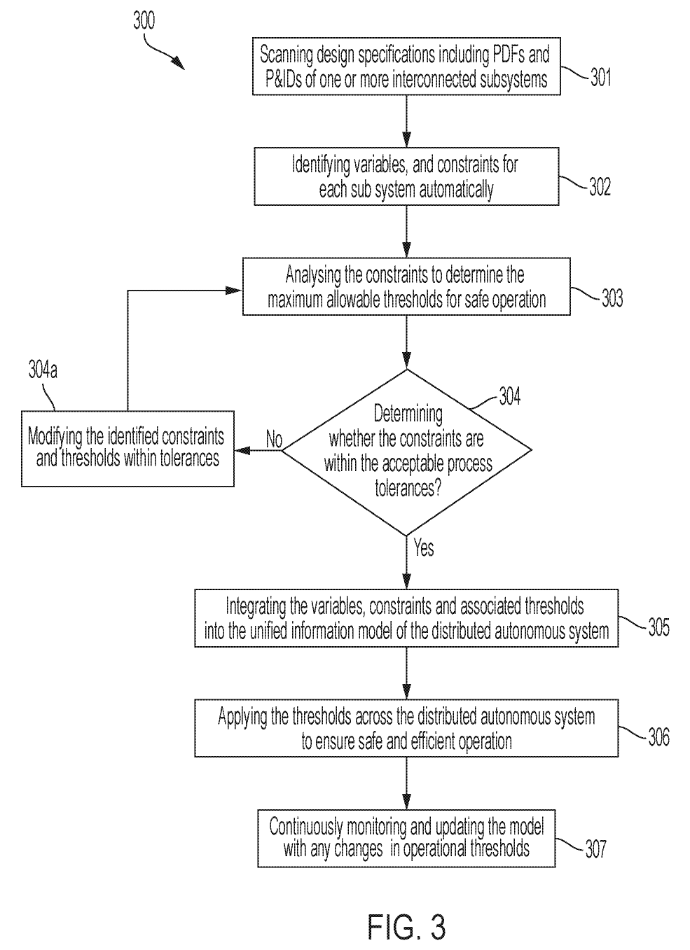

FIG. 3 illustrates a flowchart of a method 300 for developing a unified information model in accordance with an exemplary embodiment of the present invention. The method 300 comprises steps of a) scanning 301 documents associated with one or more interconnected subsystems, b) identifying 302 variables, and constraints for subsystems automatically, c) analysing 303 the constraints to determine the maximum allowable thresholds for safe operation, d) determining 304 whether the constraints are within the acceptable process tolerances, e) integrating 305 the variables, constraints and associated thresholds into a unified information model of the distributed autonomous system if the constraints are determined to be within the acceptable process tolerances, f) applying 306 the thresholds across the distributed autonomous system to ensure safe and efficient operation, and g) continuously monitoring 307 and updating the unified information model with any changes in operational thresholds.

In an embodiment of present invention, the documents scanned in 301 may include product specifications or user manuals. The step of determining 304 whether the constraints are within the acceptable process tolerances further comprises the step of modifying 304a the identified constraints and thresholds within tolerances if the constraints are determined not to be within the acceptable process tolerances.

The documents associated with one or more interconnected subsystems include at least one design specification, technical specification, process flow diagram, service manual, datasheet, piping drawing, or instrumentation drawing. The step of identifying 302 variables and constraints for subsystems comprises extracting or fetching the variables and constraints from the scanned associated documents.

The unified information model comprises a structured digital representation of the one or more interconnected subsystems, including the operational parameters, functional characteristics, and dynamic behaviours within the distributed autonomous system. The unified information model further includes relationship data that defines interdependencies between the interconnected subsystems, capturing data flows, process linkages, and resource exchanges to facilitate seamless coordination and optimisation. Additionally, the unified information model incorporates relationship data between the subsystem and the environment, accounting for external influences such as ambient conditions, supply chain interactions, and regulatory constraints, enabling the system to adapt dynamically to external variations. The model serves as an intelligence layer, integrating real-time and historical data to enhance predictive decision-making, optimise performance, and ensure stability across the interconnected network of subsystems.

The variable comprises at least one of a dependent variable, a feedforward variable, or a feedback variable. The dependent variable includes parameters whose value is influenced by one or more independent factors within the subsystem. The feedforward variable is configured to provide anticipatory adjustments based on expected subsystem variations, and the feedback variable is adapted to regulate subsystem operations in response to detected deviations from desired operating conditions. The at least one of the dependent variables, the feedforward variable, or the feedback variable includes at least one of a process control variable, a security-related variable, a network-related variable, or an inventory-related variable of the subsystem. The process control variable includes at least one of temperature, pressure, flow rate, rotational speed, chemical composition, or other operational parameters. The security-related variable comprises at least one of authentication credentials, encryption parameters, access control settings, intrusion detection statuses, or physical security indicators, the security-related variable is configured to prevent unauthorised access and ensure integrity of the subsystem and the distributed autonomous subsystem. The network-related variable comprises at least one of communication latency, bandwidth allocation, signal strength, packet loss rate, or fault detection metrics, the network-related variable is utilised to maintain reliable data exchange and connectivity between interconnected components of the subsystem. The inventory-related variable comprises at least one of raw material availability, stock levels, replenishment intervals, supply chain logistics parameters, or warehouse capacity metrics, the inventory-related variable is used to optimise resource allocation and prevent production disruptions.

The constraints comprise at least one of a hard constraint, a soft constraint, or a quality constraint. The hard constraint includes at least one of an equipment-related constraint or a sizing constraint, the equipment-related constraint further includes mechanical, electrical, or operational limitations of machinery, devices, or control systems, and the sizing constraint includes capacity restrictions, volumetric limitations, or spatial constraints of the subsystem. The soft constraint is associated with permissible deviations from a desired output, the soft constraint allows for tolerance levels, process variability, or non-critical deviations within acceptable operational thresholds. The quality constraint is directed to quality parameters of an end product. The quality constraint includes at least one of composition uniformity, purity levels, mechanical properties, dimensional accuracy, or compliance with predefined product specifications.

Alternatively, the constraints further comprise at least one of physical constraints, operational constraints, integrational constraints, or regulatory constraints of the subsystem. The physical constraints include limitations related to temperature thresholds, pressure limits, minimum or maximum batch sizes, or spatial restrictions affecting the subsystem's operation. The operational constraints include availability of raw materials, energy consumption limits, throughput restrictions, and fluctuations in production demand, the operational constraints influence process efficiency and resource utilisation. The integrational constraints comprise compatibility requirements, interoperability issues, data exchange limitations, or synchronisation requirements that affect the interaction between multiple subsystems. The regulatory constraints include industry standards, governmental regulations, environmental compliance requirements, safety protocols, and certification mandates, the regulatory constraints ensure that the subsystem operates within legally and environmentally permissible boundaries.

For example, in a steel manufacturing facility where multiple interconnected subsystems such as blast furnaces, rolling mills, cooling systems, quality control stations, and material handling units, work together to ensure smooth production. Each subsystem has specific operational parameters, constraints, and safety thresholds that must be maintained for efficient operation.

In this case of the steel manufacturing facility, method 300 initiates with the step of scanning 301 various operational documents such as equipment manuals, process flow diagrams, maintenance logs, and historical production reports. The furnace operation records are scanned to identify past temperature fluctuations and energy consumption trends. Similarly, the rolling mill data is scanned to determine ideal speed limits and cooling system performance logs to establish safe water pressure ranges. Once the step of scanning 301 is complete, the method 300 includes identification 302 of critical variables and constraints for each subsystem. In the blast furnace, key variables may include input material composition, furnace temperature, pressure levels, and gas emissions, while constraints could involve maximum allowable temperatures, pressure thresholds, and emission limits as per environmental regulations. Similarly, in the rolling mill, important variables may include roller speed, metal thickness, and cooling rates, while constraints might involve material deformation limits, acceptable product dimensions, and safety tolerances for equipment vibration.

The method 300 further includes the step of analysing 303 the constraints to determine the maximum allowable thresholds for safe operation. For instance, if the blast furnace operates at temperatures beyond 1,600°C, the temperature may risk structural damage or inefficient smelting. The analysis of constraints includes cross-referencing the thresholds with safety guidelines and energy efficiency standards to establish ideal operating limits. Subsequently, the method includes determining 304 whether the identified constraints fall within acceptable process tolerances. For example, the rolling mill speed is found to fluctuate excessively, causing dimensional inaccuracies in steel sheets. If the deviation is minor, then the deviation might be within acceptable tolerance limits, but if the deviation exceeds a predefined limit, the method includes modification 304a of the rolling speed constraint to prevent product defects and reduce equipment wear. Once the constraints are validated and adjusted, the method involves integrating 305 all variables, constraints, and associated thresholds into a unified information model. This unified information model acts as a digital representation or a digital twin of the entire manufacturing plant, ensuring that each subsystem operates in sync with the others. For example, if the blast furnace increases production, the rolling mill automatically adjusts its speed, and the cooling system adapts its water flow to maintain proper metal properties.

After integration, the method further includes applying 306 the thresholds across the distributed autonomous system to enforce safe and efficient operation. In practice, this means that if a steel sheet is cooling too quickly, the system can automatically reduce the cooling water pressure to prevent internal stress fractures in the material. Similarly, if a sudden demand surge requires increased production, the system adjusts furnace feed rates, rolling speeds, and material handling logistics dynamically. The report of the end products to be documented as per the regulatory guidelines or compliance is generated concerning each production batch.

Additionally, the method 300 utilises machine learning (ML) to automate the identification, analysis, and management of variables and constraints of one or more interconnected subsystems within a distributed autonomous system. For example, in the step of scanning 301, natural language processing (NLP) algorithms enable the extraction of relevant operational parameters from associated documents, and the step of identifying 302 includes pattern recognition to detect key constraints. The step of analysing 303 utilises predictive analytics to determine maximum allowable thresholds based on historical and real-time data, and in the determination step 304, machine learning classification models assess whether the constraints fall within acceptable tolerances or thresholds, predicting deviations and suggesting corrective actions. The step of integrating 305 includes structuring the parameters into a unified information model, continuously refined through deep learning algorithms, and the application 306 enforces thresholds across the distributed system, dynamically adjusting workflows using artificial intelligence (AI)-driven optimisation. Finally, the monitoring and updating step 307 may employ real-time machine learning monitoring frameworks to track changes, refine operational thresholds, and proactively adapt the system to maintain efficiency, safety, and compliance.

FIGS. 4A and 4B provides an illustration of an interface 400 for controlling a distributed autonomous system in accordance with an exemplary embodiment of the present invention. The interface 400 provides an immersive view of the distributed autonomous system including interactive control of a hierarchical structure and individual components of the subsystem. The hierarchical structure is disclosed in a scrollable side section, a tree of systems, subsystems and connections is provided for the user’s selection and control. The interface further includes a graphical section to visualise the system, subsystems or connections selected by the user. FIG. 4A illustrates the overall distributed system including the subsystem 1, subsystem 2, subsystem 3 and associated connections S1-S2 and S2-S3 in the graphical section as per the user selection “Distributed System” in the hierarchical tree provided in the side section. FIG. 4B illustrate the subsystem 3 including component 1, component 2, component 3, component 4 and associated connections C1-C2, C1-C3, C2-C3 and C2-C4 in the graphical section as per the user selection “Subsystem 3” in the hierarchical tree provided in the side section.

The interface 400 is further configured to allow the user to set at least one desired outputs or target state for the subsystem. The interface enables the user to select a component, subsystem, or connection either from the hierarchical tree or the graphical section and show a sub-interface either within the side section or the graphical section to allow user to set the desired output or target state for selected component, subsystem or connection. Alternatively, the hierarchical tree in the side section and associated graphical section are provided based on a unified information model of the distributed system.

The interface 400 is configured to dynamically generate and display a sub-interface in response to a user hovering over at least one graphical element within the graphical section. The sub-interface may be presented as an overlay, pop-up window, dropdown menu, or any other suitable graphical element that facilitates user interaction. The sub-interface provides the user with options to define, modify, or select a desired output or target state associated with the graphical element.

The sub-interface may include, but is not limited to, interactive elements such as selectable buttons, sliders, dropdown menus, text input fields, or toggle switches that allow the user to input specific parameters or preferences. The interface 400 may further enhance the usability of the sub-interface by incorporating contextual tooltips, visual indicators, or real-time previews of the selected target state. Additionally, the sub-interface may support hierarchical or nested configurations, and selecting a primary option reveals further sub-options for granular control over the graphical element’s attributes.

The interface 400 further enables the user to selectively toggle the mode of a graphical section between a two-dimensional (2D) viewing mode and a three-dimensional (3D) viewing mode. In the 2D viewing mode, graphical elements are rendered in a planar representation, whereas in the 3D viewing mode, the graphical section is configured to display objects with depth and spatial positioning to provide a more comprehensive visual representation.

The interface 400 enables the user to toggle between an immersive 3D viewing mode and a standard 3D viewing mode. In the immersive 3D viewing mode, the graphical section is provided to enhance user engagement by incorporating depth perception, real-time spatial orientation adjustments, and dynamic viewpoint manipulation, potentially utilising technologies such as stereoscopic rendering, virtual reality (VR) integration, augmented reality (AR) integration, or head-tracking mechanisms. This mode may allow users to navigate, interact with, and manipulate the graphical elements. The standard 3D viewing mode provides a conventional three-dimensional representation of the graphical section, where objects are rendered with depth but without additional immersive enhancements. The transition between the modes is facilitated by a toggle mechanism, which may be implemented through a graphical user interface (GUI) element, a physical control input, a predefined gesture, or a system command. The interface 400 is provided with dynamic adjustment of the graphical rendering and user interaction capabilities based on the selected mode, ensuring a seamless transition between different visualisation experiences.

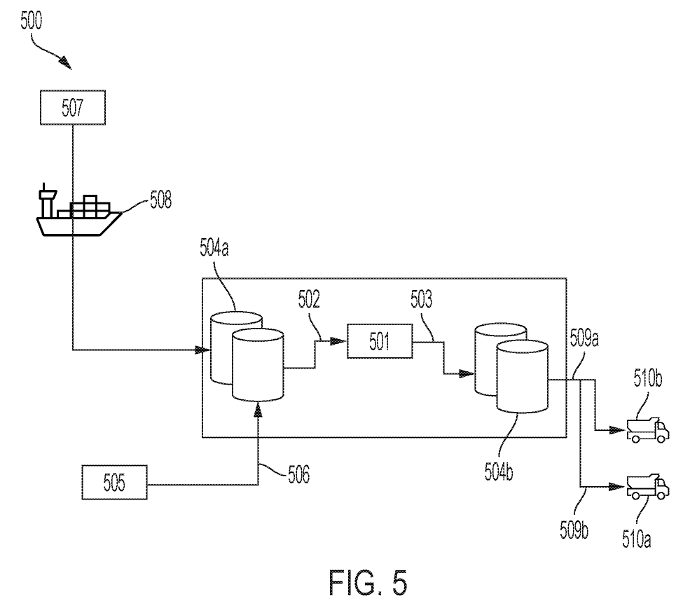

FIG. 5 discloses an illustration of a distributed autonomous system 500 in accordance with an exemplary embodiment of the present invention. The distributed autonomous system 500 comprises a refinery subsystem 501, an input storage subsystem 504a connected to the refinery subsystem 501 through an input transportation subsystem 502, and an output storage subsystem 504b connected to the refinery subsystem 501 through an output transportation subsystem 503. The input storage subsystem 504a is arranged to receive input raw material from a first external raw material storage 505 through an input pipeline 506, and from a second external raw material storage 507 through a ship 508. The output storage subsystem 504b is arranged to send out the output product to transportation trucks (510a, 510b) through output pipelines (509a, 509b).

The distributed autonomous system 500 further includes a processor (not shown here) operably connected to the one or more interconnected subsystems, the processor is configured to execute a set of control and optimisation functions. The processor provides an interface that enables user interaction with the system, facilitating real-time monitoring and control of plant operations. The processor is further configured to detect at least one variable and constraint associated with the input storage subsystem 504a, the refinery subsystem 501, and the output storage subsystem 504b. Variables such as raw material flow rate, processing efficiency, storage levels, and transportation availability are continuously monitored to determine the current state of the system.

The processor is configured to detect the at least one variable and constraint associated with the input storage subsystem 504a, the refinery subsystem 501, and the output storage subsystem 504b using a unified information model of the distributed autonomous system 500. For the input storage subsystem 504a, the unified information model consolidates data related to inventory levels, material properties, inflow rates, and storage conditions, allowing precise tracking and forecasting of raw material availability. For the refinery subsystem 501, the model incorporates process parameters such as reaction kinetics, catalyst efficiency, pressure, temperature, and energy consumption, enabling the processor to optimise refining operations dynamically. For the output storage subsystem 504b, the model includes product specifications, dispatch schedules, storage constraints, and distribution logistics, ensuring a streamlined flow of refined products. Additionally, the unified information model defines relationships between the subsystems, capturing dependencies such as the impact of raw material composition on refining efficiency or how processing conditions affect final product quality.

Based on the monitored variables and constraints, the processor simulates the behaviour of the distributed autonomous system 500 to predict an optimised workflow. The simulation is performed based on a predefined desired output. The processor analyses system dynamics to determine an optimised sequence of operations. Using real-time and historical data, the processor identifies bottlenecks, predicts potential system failures, and recommends corrective actions to enhance overall efficiency.

The processor further determines the current state of each subsystem by continuously assessing real-time data from sensors and system logs. Using this information, the processor predicts an optimised workflow to achieve the desired output by integrating the current state data with the simulated behaviour of the distributed autonomous system 500. The predicted workflow includes adjustments in transportation scheduling, input material allocation, and processing parameters to ensure seamless operations.

To implement the predicted optimised workflow, the processor initiates a trigger within the relevant subsystems to transition them to the next target state. This may include activating control mechanisms to adjust pipeline flow rates, dynamically reallocating storage capacities, modifying processing parameters in the refinery subsystem 501, or dispatching the transportation trucks (510a, 510b) in alignment with output schedules. The autonomous execution of the triggers ensures that the system adapts to changing operational conditions while maintaining optimal performance and efficiency. For example, an oil refinery implementing the distributed autonomous system comprises interconnected subsystems, including a crude oil input storage unit, a refining unit, and an output distribution system. The system is managed by a processor that provides an interface for real-time monitoring and control of refinery operations. The processor detects key variables such as crude oil flow rate, processing temperature, and storage capacity while accounting for constraints like pipeline pressure limits and refinery throughput. By simulating the system behaviour based on desired output targets, the processor predicts an optimised workflow, adjusting crude oil intake, refining parameters, and product distribution schedules accordingly. Upon determining the optimal process, the system autonomously triggers adjustments in crude oil transportation, refining efficiency, and dispatch logistics to ensure seamless operations, minimising downtime, reducing waste, and maximising overall productivity.

The distributed autonomous system 500 is further influenced by various external factors that impact its operational efficiency and overall workflow. The external influences include the availability and scheduling of the ships 508 transporting raw materials, dynamic cost of transportation, the capacity and throughput of the external pipelines 506, the storage levels in the external raw material storage units (505, 507), and the scheduling of the transport trucks (510a, 510b) responsible for dispatching processed output. Each of the external factors introduces constraints and dynamic variables that must be continuously monitored and optimised to ensure seamless plant operations. Additionally, the processor treats external influences as external integrated subsystems and part of the distributed autonomous system 500.

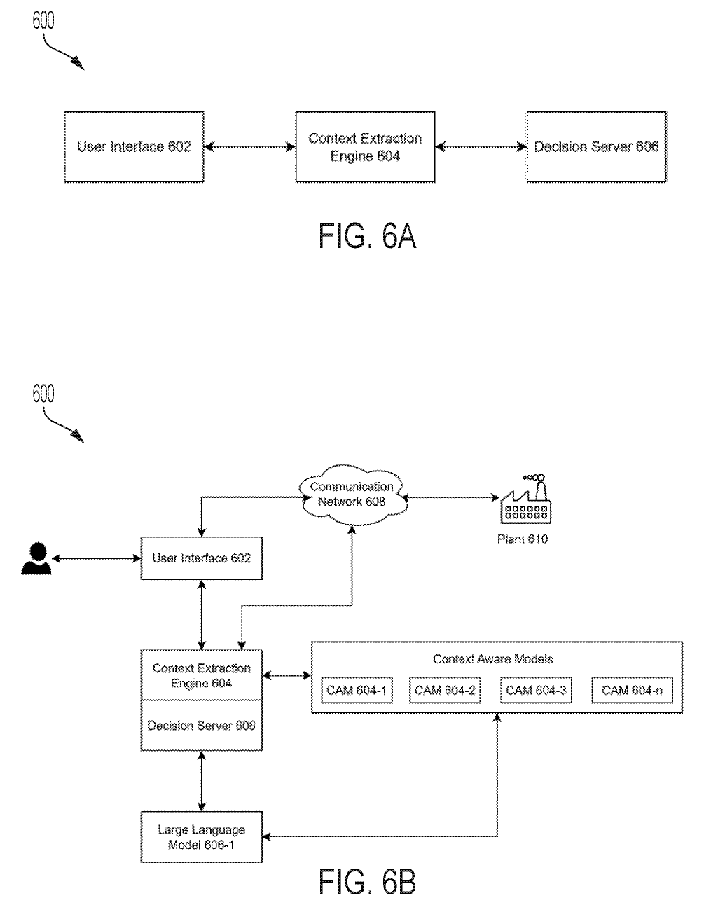

FIG. 6A illustrates a system 600 for managing plant 610 operations in accordance with an exemplary embodiment of the present invention. The system 600 comprises a user interface 602, a context extraction engine 604, and a decision server 606.

The user interface 602 displays an interconnected plurality of plant subsystems, each corresponding to different operational sections of the plant 610. In one example, the plurality of the plant subsystems may include, but are not limited to, equipment such as boilers, turbines, compressors, pumps, heat exchangers, or control modules. The user interface 602 provides a unified, interactive view of the entire plant 610, enabling streamlined monitoring and control.

A user is typically a plant operator, engineer, or technical supervisor who interacts with the user interface 602 to select at least one plant subsystem from the plurality of displayed plant subsystems. Upon selecting the plant subsystem, the user interface 602 receives a prompt related to the selected plant subsystem. The user interface 602 may further filter and display the plurality of plant subsystems based on the user roles or access permissions.

In one exemplary scenario, the user accesses the user interface 602 and inputs an API key to enable advanced image processing capabilities. The user uploads an image, for example, a process flow diagram (PFD) of a naphtha splitting process, which may include equipment comprising a splitter column, heat exchanger, control valves, or sensors. The system 600 uses machine learning algorithms to parse the image and extract relevant components. For example, in a naphtha splitting process, the system 600 identifies the splitter column as the central equipment, with input streams (naphtha feed) and output streams (distillate and bottoms). The system 600 then generates a textual process description, such as: “The process involves a naphtha splitting operation, where naphtha is fed into a splitter column and the column is heated via a heat exchanger, controlled by valves and monitored by sensors, producing distillate and bottoms as outputs”.

The prompt includes at least one goal, target, or query related to the selected subsystem. For example, the user may request operational parameters (such as temperature, pressure, or flow rate), inquire about diagnostic status, initiate control adjustments, or request optimization recommendations. The prompts are provided by the user in natural language, ensuring ease of use without requiring the operator to manually enter complex configuration codes.

### Examples

Goal or Target Setting: The user may select the boiler subsystem from the plurality of subsystems displayed on the user interface 602 and provide a natural language goal such as, “Optimize boiler for maximum fuel efficiency over the next 8 hours”.

User Query: The user may select the turbine subsystem and submit a natural language query such as, “What is the current vibration level of the turbine?”

The system 600 may operate in two distinct modes: an interactive mode and an autonomous mode. The interactive mode corresponds to user queries, where the operator engages with the system 600 in real-time to request specific information, such as operational parameters, diagnostic data, or the status of a subsystem from the plant 610. In contrast, the autonomous mode corresponds to goal or target setting, where the user defines a desired operational outcome or objective in natural language. The system 600 performs optimization, monitoring, or control actions to achieve the specified target without requiring further manual intervention, as explained in detail below.

In the one exemplary scenario, after generating the process description, the system 600 further presents a variable selection on the user interface 602. Users select input variables (for example, feed flow rate, heating medium temperature, reflux ratio) and output variables (for example, distillate flow rate, bottoms flow rate, column temperature, column pressure). The user interface 602 may also provide units for clarity (for example, T/H for flow rates, °C for temperatures, bar for pressure) and allows optional variables to be included or excluded based on process relevance.

The user interface 602 includes a semantic parser that interprets a prompt provided by the user and converts the prompt into structured tuning directives. The semantic parser performs natural language understanding on the prompt, which may be expressed in free-form natural language, and derives one or more relevant operational variables, actions, or goals associated with the selected plant subsystem. Once the prompt has been parsed, the semantic parser generates structured tuning directives in a machine-readable format, which are transmitted to the context extraction engine 604 for further processing.

In one exemplary scenario, the user interface 600 of the system 602 further enables the users to input experimental or operational data. For example, the user may input a change in feed flow rate from 45 T/H to 50 T/H and a corresponding shift in distillate flow rate from 2.3 T/H to 2.9 T/H, with a specified time delay of 15 seconds. The users may also input time series data, for example, distillate flow rate values at specific timestamps (for example, t=0s, 2.3 T/H, t=30s, 2.5 T/H). The system 600 processes this data using machine learning algorithms to train models (context-aware models, large language models, or other models explained below) that capture the dynamic behavior of the process, including response lags and variable interdependencies.

The user interface 602, the context extraction engine 604, and the decision server 606 may be integrated into a single unit, minimizing the need for external communication links and simplifying the architecture for compact or remote industrial sites. Alternatively, the user interface 602, the context extraction engine 604, and the decision server 606 may be communicatively connected using a communication network 608, as shown in FIG. 6B. The communication network 608 may employ any suitable wired or wireless communication protocols, but are not limited to, radio frequency (RF), infrared data communication (IrDA), Bluetooth, ZigBee and IEEE 802.15 variants, Wi-Fi (IEEE 802.11 variations), WiMAX (IEEE 802.16 variations), global system for mobile communication (GSM), general packet radio service (GPRS), enhanced data rates for GSM Evolution (EDGE), long term evolution (LTE), and next-generation cellular protocols (2G through 5G). Additionally, near field communication (NFC), satellite-based communications, or proprietary industrial communication protocols may also be supported. This ensures that the system 600 architecture remains flexible and scalable for different plant 610 environments.

The context extraction engine 604 incorporates, or may be operatively connected to, one or more processing units or processors, as well as memory units. The processing units execute one or more algorithms or models, while the memory units store the algorithms, context-aware models (604-1, 604-2, 604-3,….,604-n), training datasets, parsed prompts, historical data, hierarchical division of the subsystems, operational logs or real-time variable data of the subsystems for enabling contextual interpretation and adaptive decision-making.

The context-aware models (604-1, 604-2, 604-3,….,604-n) used by the context extraction engine 604 are typically specialized small language models tailored for industrial plant 610 environments. The context-aware models (604-1, 604-2, 604-3,….,604-n) may comprise at least one of rule-based models for deterministic decisions, statistical models for pattern or trend detection and probability analysis, or generative artificial intelligence (AI) models for flexible interpretation of ambiguous prompts or predictive reasoning. The rule-based model relies on predetermined logical rules and if-then conditions that represent expert knowledge about the plant 610 operations. The statistical models use historical data analytics, machine learning, and probabilistic approaches to identify trends. The generative artificial intelligence (AI) model, such as a deep neural network or transformer-based architecture, may create new hypotheses, simulate plant 610 behaviors, or fill in missing data based on learned patterns. For example, the rule-based models may address straightforward control logic, while the generative AI models handle complex or unstructured data scenarios. Using multiple model types together enhances the robustness and adaptability of hypothesis generation within diverse operational contexts. The context-aware models (604-1, 604-2, 604-3,….,604-n) are trained and tuned based on the one or more subsystems of the plant 610, or fine-tuned for predefined operational goals, such as efficiency optimization, predictive maintenance, or fault diagnosis. The integration of different modeling approaches ensures a balance between robustness, explainability, and adaptability across different operational contexts.

Depending on the use case, the system 600 employs different types of the context-aware models (604-1, 604-2, 604-3,….,604-n). Multiple model types may be invoked independently or collaboratively for hypothesis generation, ensuring reliable handling of both routine and complex operational contexts.

In one scenario, the context extraction engine 604 dynamically selects models based on real-time plant 610 states or operational requirements. During normal operations, rule-based models may suffice. However, in fluctuating or abnormal conditions, statistical or generative AI models may be activated to analyze complex variable patterns. Dynamic switching between models ensures a balance between computational efficiency and diagnostic adaptability.

Based on derived variables from the prompt and real-time values collected through the communication network 608 from the plant 610, the context extraction engine 604 selects and activates a suitable context-aware model 604-1. The context extraction engine 604 then generates a contextual hypothesis or checks data sufficiency, depending on the type of prompt.

For example, when the user sets a goal such as “Optimize boiler for maximum fuel efficiency over the next 8 hours”, the context extraction engine 604 receives real-time plant 610 data through the communication network 608, such as “boiler load (78% of rated capacity), fuel flow rate (245 kg/hr), flue gas oxygen concentration (3.6%), combustion efficiency (94.7%), and forecasted steam demand of up to 82% load”. Based on these inputs, the context extraction engine 604 generates contextual hypotheses such as: (i) adjusting the air-to-fuel ratio by reducing excess oxygen from 3.6% to 3.2% to achieve efficiency above 96%, (ii) regulating output to remain near 80% load to sustain efficiency above 95% across the forecast window, or (iii) synchronizing fuel feed with demand peaks to reduce overshoot losses and save about 1.5% in fuel consumption.

In another example, when the user provides the query “What is the current vibration level of turbine?”, the context extraction engine 604 retrieves real-time vibration data and performs a data sufficiency check to determine whether the prompt received from the user contains enough information to be processed by the small language model. If the lubrication pressure sensor data is missing, the context extraction engine 604 flags insufficiency.

In yet another example, when the user queries “What is the current vibration level of turbine?”, the context extraction engine 604 retrieves real-time plant 610 data through the communication network 608, such as “vibration data showing 3.2 mm/s RMS and bearing temperature at 74°C”, and also checks that the lubrication pressure sensor data is missing. Since this value is critical for interpreting vibration anomalies, the context extraction engine 604 flags data insufficiency.

The generated hypothesis or the result of the data sufficiency checks or data insufficiency is subsequently transmitted to the decision server 606 for evaluation and the generation of contextual data. The decision server 606 functions as a validation and decision-making module, ensuring that any hypothesis or outcome produced by the context extraction engine 604 is consistent with plant 610 operations, historical patterns, and statistical models. More specifically, the decision server 606 evaluates the hypothesis by validating the generated contextual hypothesis or the context of the checked data sufficiency against the received prompt, employing one or more statistical consistency tests. These consistency tests may analyze correlations, detect anomalies, or perform probability checks to ensure that the outcomes derived are reliable. Once validated, the decision server 606 provides one or more control actions back to the plant subsystem or sends operational feedback to the user through the user interface 602.

In one example, the decision server 606 may further employ rule-based logic, trend analysis, or machine learning-driven inference models to refine the validation process by comparing the hypothesis against historical operational baselines, predictive forecasts, and domain-specific constraints. The decision server 606 may also dynamically weigh data confidence levels and context relevance to prioritize specific hypotheses or reject those determined to be inconsistent with operational objectives. In response to such determinations, the decision server 606 may automatically update control setpoints within the plant subsystem, initiate corrective sequences to prevent potential inefficiencies or failures, or escalate alerts to supervisory operators when manual intervention is deemed necessary. Thus, the decision server 606 ensures that only contextually valid, statistically consistent, and operationally safe hypotheses translate into actionable plant 610 directives or user-facing insights.

In situations where a generated contextual hypothesis proves unresolved, invalid, or where a context derived from a data sufficiency check cannot be resolved, the decision server 606 escalates the scenario. In such cases, the unresolved or invalid outcomes are transferred to a large language model (LLM) 606-1. The LLM 606-1 may be deployed either within the decision server 606 or hosted separately on a remote computing system connected to the decision server 606 via the communication network 608. The role of the LLM 606-1 is to process complex, ambiguous, or incomplete scenarios where the smaller, context-aware models (604-1, 604-2, 604-3,…,604-n) are unable to generate sufficient contextual clarity. The large language model (LLM) 606-1 generates supplemental contextual data, which is then provided back to at least one context-aware model 604-1 used by the context extraction engine 604, enabling continued training and refinement. By invoking the LLM 606-1 only when an outcome is unresolved or invalid, the system 600 reduces the overall computing resources required to generate contextual data and control actions, thereby ensuring efficient utilization of processing capacity while maintaining high accuracy.

Valid outcomes from hypothesis evaluation also play a vital role in refining model performance over time. Each validated outcome leads to prompt-driven adaptive adjustments within the context-aware model 604-1. Such refinements may involve updating embedding vectors representing the parsed prompt, tuning adapter weights, or modifying the attention mechanism of the context-aware model 604-1. This iterative fine-tuning process enhances the system's 600 ability to interpret future prompts and adapt to evolving plant 610 conditions accurately.

When the large language model (LLM) 606-1 processes an unresolved or non-resolvable context and is unable to generate the required contextual data, the LLM 606-1 requests additional prompts or clarification. In particular, the LLM 606-1 may prompt the user to provide a supplemental query or specific instructions regarding the missing data. This interactive loop ensures that incomplete or insufficient data sets are supplemented through user intervention, thereby improving both the breadth and precision of the contextual hypotheses generated by the system 600.

Over time, the system 600 leverages iterative refinements from not only validated hypotheses but also from user feedback loops, continuously enhancing its training base and improving decision accuracy. This iterative learning mechanism ensures that the context-aware models (604-1, 604-2, 604-3,….,604-n) remain up-to-date, plant 610 specific, and sensitive to both routine and unforeseen operational scenarios.

The one or more control actions may include, but are not limited to, alerts, recommendations, or warnings. These actions are generated by the decision server 606 in response to validated hypotheses or confirmed sufficiency checks and communicated either directly to the user through the user interface 602 or to the connected plant subsystem for execution.

The system 600 may be implemented in software, hardware, or a combination thereof. The hardware includes processors, memory, communication modules, sensors, and actuators, while software comprises executable instructions, algorithms, machine-learning models, databases, or firmware running on computing devices. The software controls hardware components based on input data, predefined rules, or real-time conditions.

In one Scenario: Valid Hypothesis and Control Actions: The user provides a goal: “Optimize boiler for maximum fuel efficiency over the next 8 hours.” The semantic parser in the user interface 602 derives fuel efficiency as the operational goal. The context extraction engine 604 then uses this goal along with real-time values, such as “boiler load at 78% of rated capacity, fuel flow rate at 245 kg/hr, flue gas oxygen concentration at 3.6%, current steam output of 52 tons/hr, and measured combustion efficiency at 94.7%”. Based on this, the context extraction engine 604 generates a contextual hypothesis that efficiency can be optimized by (i) reducing oxygen concentration to 3.2% through fine‑tuning the air-to-fuel ratio, and (ii) stabilizing steam output at 80% capacity. The decision server 606 evaluates the contextual hypothesis by validating it against the prompt‑derived goal using statistical consistency tests applied to historical boiler efficiency logs. Upon confirmation, control actions are issued, including adjusting burner airflow dampers, regulating the feedwater inlet, and scheduling 30-minute efficiency monitoring intervals.

In a second scenario: Invalid Hypothesis and Escalation to LLM 606-1: The user provides the goal: “Optimize boiler for maximum fuel efficiency over the next 8 hours”. The prompt-derived value is: “maximize efficiency within the set horizon”. The context extraction engine 604 considers real-time values: “boiler load at 92%, fuel flow at 280 kg/hr, oxygen at 3.1%, and efficiency at 93.2%”. From this, the context extraction engine 604 generates a contextual hypothesis stating that efficiency can be improved by driving steam output to 100% of rated capacity and reducing oxygen below 3.0%. The decision server 606 evaluates the contextual hypothesis against the prompt using statistical consistency tests, revealing it to be invalid: “pushing oxygen closer to 3.0% risks fuel-rich conditions, and loading at 100% causes exchanger losses that reduce net efficiency”. As the hypothesis fails, the case is escalated to LLM 606-1, which integrates the efficiency optimization goal with historical operational baselines. The LLM 606-1 recommends corrections, such as maintaining a boiler load between 85%-88% and an oxygen level between 3.2%-3.4%. This validated corrective analysis is then used to retrain the context-aware model 604-1.

In a third scenario: Non-Resolvable Context and User Prompt Request: The user queries, “Is boiler operating with optimal fuel efficiency today?” The prompt-derived value is: “evaluate current efficiency status today”. The context extraction engine 604 utilizes available real-time inputs: “boiler load at 75%, steam output of 50 tons/hr, oxygen content at 3.5%, and combustion efficiency at 94.5%”. However, the calorific value of today’s fuel is missing, which prevents the establishment of efficiency baselines. The decision server 606 evaluates context sufficiency against the efficiency-evaluation prompt using statistical checks and determines that the context is insufficient to support a valid hypothesis. The scenario is escalated to LLM 606‑1, which interpolates calorific values from historical supply records (e.g., 4,200 kcal/kg), but finds statistical consistency below acceptable thresholds. The LLM 606-1 concludes validation cannot proceed and issues a clarifying prompt: “Please provide today’s fuel calorific value”. After the user supplies 4,100 kcal/kg, the decision server 606 reprocesses the prompt goal and completes the data set, reevaluates sufficiency, and generates a validated hypothesis with corresponding corrective actions.

In a fourth scenario: Iterative Refinement Based on User Feedback: Over repeated optimization prompts provided for boiler, real-time monitoring shows that efficiency ratings improve slightly (from 94.7% to 95.2%), but derived values of net fuel consumption indicate an overall increase of 3-4% due to constant near-maximum load operation. The user reports through the user interface 602 that these adjustments result in excessive coal consumption compared to gains in steam production. This operational feedback is ingested by the decision server 606, which refines adapter weights in the context-aware model 604-1. Specifically, the context-aware model’s 604-1 optimization vector is updated to reduce overemphasis on theoretical efficiency gains and increase priority for consumption-to-output ratios under real conditions. In subsequent queries, the context extraction engine 604 generates hypotheses that combine derived marginal efficiency improvements with real-time consumption rates, recommending operational targets such as “capping boiler load to 80–82% rather than exceeding 90%”. Over iterations, the system’s 600 hypotheses converge to align closely with plant 610 reality, improving both efficiency and sustainability.

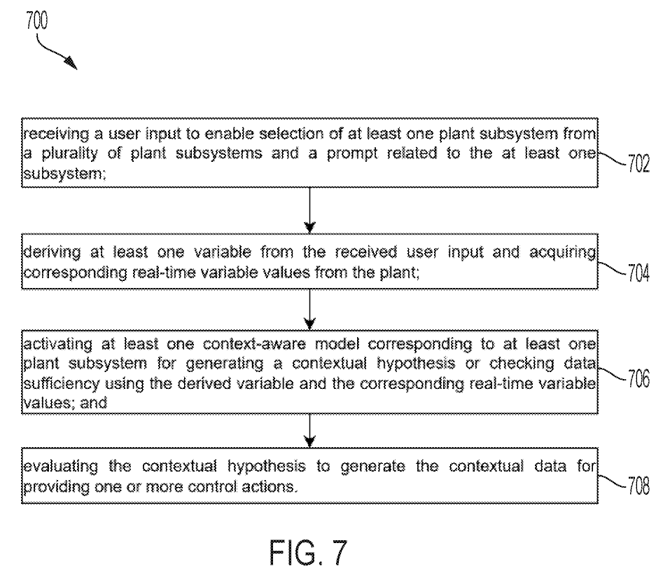

FIG. 7 illustrates a method 700 for managing plant operations in accordance with an embodiment of the present invention. The method 700 comprises the step of: a) receiving 702, a user input to enable selection of at least one plant subsystem from a plurality of plant subsystems and a prompt related to the at least one subsystem; b) deriving 704, at least one variable from the received user input and acquiring corresponding real-time variable values from the plant; c) activating 706, at least one context-aware model corresponding to at least one plant subsystem for generating a contextual hypothesis or checking data sufficiency using the derived variable and the corresponding real-time variable values; and d) evaluating 708, the contextual hypothesis to generate the contextual data for providing one or more control actions.

The method 700 enables efficient and intelligent management of plant operations by integrating user input, real-time data acquisition, and context-aware models to generate reliable contextual hypotheses. This approach ensures that plant subsystems are monitored and controlled dynamically through accurate evaluation of real-time variables, thereby improving decision-making, enhancing operational efficiency, and reducing the likelihood of errors or inefficiencies. By providing contextual data for actionable control, the method 700 optimizes plant performance, supports predictive analysis, and facilitates adaptive responses to changing operational conditions.

The method 700 further comprises interpreting the received prompt and converting the prompt into structured tuning directives to ensure seamless processing of the user prompt. This provides improved clarity in communication between the operator and the system, minimizing ambiguity and enhancing accuracy in subsystem selection and tuning.

The real-time variable values in step 704 are received from one or more interconnected subsystems of the plant through a communication network. This provides comprehensive situational awareness and promotes synchronized control across different plant subsystems, thereby reducing delay and improving responsiveness.

The context-aware models in step 706 employ at least one of a rule-based model, a statistical model, or a generative artificial intelligence (AI) model. The activation further includes transferring the received request to a large language model (LLM) and tuning one or more context-aware models on at least one of a set of subsystems of the plant or for a predefined purpose. The method 700 also iteratively refines the at least one context-aware model based on user feedback. This enables adaptive, flexible, and intelligent responses for the plant subsystem, allowing for continuous learning and refinement to optimize operation.

The evaluation in step 708 of the hypothesis includes validating the generated contextual hypothesis or context of the checked data sufficiency against the prompt using one or more statistical consistency tests. This step 700 ensures that the contextual hypotheses remain logically consistent and reliable, reducing the possibility of errors in decision-making.

The method 700 further comprises generating contextual data using a large language model and providing the generated contextual data to at least one context-aware model for training, in response to unresolved or invalid outcomes from evaluating the contextual hypothesis or non-resolvable context from data sufficiency checking.

The evaluation in step 708 also involves adjusting at least one of the embedding vectors representing the prompt, adapter weights, or attention mechanism of the context-aware model in response to valid outcomes. This enhances robustness and system intelligence by enabling automated adaptation, retraining, and fine-tuning, thereby improving operational accuracy over time.

The method 700 further comprises requesting an additional prompt from the user when the large language model is unable to process a non-resolvable context for generating contextual data. This provides a reliable fallback mechanism to ensure the uninterrupted functioning of the system and prevents deadlocks in decision support or control workflows.

Upon successful evaluation in the step 708, the method comprises generating contextual data for providing one or more control actions to optimize the selected plant subsystem. The contextual data may also be stored or used for predictive or preventive actions in future operations. This ensures efficient real-time control, predictive optimization, and long-term adaptive improvements in plant operations, thereby enhancing productivity and reliability.

The above stated descriptions are merely example implementations of this application but are not intended to limit the protection scope of this application. A person with ordinary skills in the art may recognise substantially equivalent structures or substantially equivalent acts to achieve the same results in the same manner or a dissimilar manner; the exemplary embodiment should not be interpreted as limiting the disclosure to one embodiment.

While aspects of the present disclosure have been described in detail with reference to the illustrated embodiments, those skilled in the art will recognise that many modifications may be made thereto without departing from the scope of the present disclosure. The present disclosure is not limited to the precise construction and compositions disclosed herein; any and all modifications, changes, and variations apparent from the foregoing descriptions are within the spirit and scope of the disclosure as defined in the appended claims. Moreover, the present concepts expressly include any and all combinations and subcombinations of the preceding elements and features.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognised as being functionally equivalent or structurally equivalent to the aspect shown or described. A function or an act should be interpreted as incorporating all modes of performing the function or act unless otherwise explicitly stated.

The description is provided for clarification purposes and is not limiting. Words and phrases are to be accorded their ordinary, plain meaning unless indicated otherwise.

We claim:

1. A system for managing plant operations, comprising:
a user interface to enable selection of at least one plant subsystem from a plurality of plant subsystems and to receive a prompt related to the at least one plant subsystem;
a context extraction engine to employ one or more context-aware models and to selectively activate the at least one context-aware model for generating a contextual hypothesis or to check data sufficiency for the selected plant subsystem, based on at least one derived variable from the prompt and corresponding real-time variable values; and
a decision server to evaluate the contextual hypothesis for generating the contextual data to provide one or more control actions.

2. The system according to claim 1, wherein the user interface includes a semantic parser to interpret the prompt and convert the prompt into structured tuning directives.

3. The system according to claim 1, wherein the one or more context-aware models are trained and tuned on at least one of a set of subsystems of the plant or a predefined purpose.

4. The system according to claim 1, wherein the real-time variable values are received from one or more interconnected subsystems of the plant through a communication network.

5. The system according to claim 1, wherein the one or more context-aware models employ at least one of a rule-based model, a statistical model, or a generative artificial intelligence (AI) model.

6. The system according to claim 1, wherein the decision server evaluates the contextual hypothesis by validating the generated contextual hypothesis or context of the checked data sufficiency against the prompt using one or more statistical consistency tests.

7. The system according to claim 6, wherein unresolved or invalid outcomes from the contextual hypothesis generation or a non-resolvable context from the checked data sufficiency are transferred to a large language model for generating and providing contextual data to the at least one context-aware model for training.

8. The system according to claim 6, wherein valid outcomes corresponding to the prompt adjust at least one of the embedding vectors representing the prompt, adapter weights, or the attention mechanism of the at least one context-aware model.

9. The system according to claim 7, wherein the large language model requests an additional prompt when the large language model is incapable of processing the non-resolvable context to generate the contextual data.

10. The system according to claim 1, wherein the at least one context-aware model is iteratively refined based on user feedback.

11. A method for managing plant operations comprising:
receiving a user input to enable selection of at least one plant subsystem from a plurality of plant subsystems and a prompt related to the at least one subsystem;
deriving at least one variable from the received user input and acquiring corresponding real-time variable values from the plant;
activating at least one context-aware model corresponding to at least one plant subsystem for generating a contextual hypothesis or checking data sufficiency using the derived variable and the corresponding real-time variable values; and
evaluating the contextual hypothesis to generate the contextual data for providing one or more control actions.

12. The method according to claim 11, wherein evaluating the contextual hypothesis includes validating the generated contextual hypothesis or context of the checked data sufficiency against the prompt using one or more statistical consistency tests.

13. The method according to claim 12, wherein evaluating the contextual hypothesis comprises generating contextual data using a large language model and providing the generated contextual data to at least one context-aware model for training in response to unresolved or invalid outcomes from evaluating the contextual hypothesis or non-resolvable context from data sufficiency checking.

14. The method according to claim 12, wherein evaluating the contextual hypothesis comprises adjusting at least one of the embedding vectors representing the prompt, adapter weights, or the attention mechanism of the at least one context-aware model in response to valid outcomes.

15. The method according to claim 13, wherein evaluating the contextual hypothesis comprises requesting an additional prompt when the large language model is incapable of processing the non-resolvable context to generate the contextual data.

16. The method according to claim 11, wherein activating at least one context-aware model includes transferring the request to a large language model and tuning the one or more context-aware models on at least one of a set of subsystems of the plant or a predefined purpose.
